(19) United States
(12) Patent Application Publication
(10) Pub. No.: US 2017/0074336 A1
(43) Pub. Date: Mar. 16, 2017

(54) DISC BRAKE ASSEMBLY

(71) Applicant: PERFORMANCE FRICTION CORPORATION, Clover, SC (US)

(72) Inventor: Donald L. Burgoon, Gastonia, NC (US)

(21) Appl. No.: 15/268,188

(22) Filed: Sep. 16, 2016

Related U.S. Application Data
(60) Provisional application No. 62/219,492, filed on Sep. 16, 2015.

(51) Int. Cl. F16D 65/12

(52) U.S. Cl. CPC F16D 65/123; F16D 2065/1316

(57) ABSTRACT

A disc brake assembly including a disc brake rotor secured between a mounting assembly and a taper-locking hold down ring. Also provided is a method of securing a disc brake rotor to a mounting assembly including a hub, a hat or a mount. The method includes providing a mounting assembly having a cylindrical body with a mounting flange on a first end of said cylindrical body; fixedly mounting a disc brake rotor onto said cylindrical body; and mounting a taper-locking hold down ring on a second end of the cylindrical body, opposite said mounting flange and biased against the disc brake rotor, such that the disc brake rotor is restricted from rotational or axial movement relative to the cylindrical body.

### RELATED APPLICATION

This application claims priority to U.S. Provisional Application No. 62/219,492, filed on Sep. 16, 2015, the contents of which are hereby incorporated by reference in their entirety.

### FIELD

The present disclosure relates to a disc brake assembly which is both light weight and cost effective. The disc brake assembly includes a disc brake rotor secured between a mounting assembly and a taper-locking hold down ring.

### BACKGROUND

One common type of brake design for vehicles is a two piece rotor and hub in which a rotor that carries the braking surface is detachably connected to a wheel hub. Another common type of brake design is an integrated one-piece rotor and hub assembly.

Integrated one-piece rotor and hub assemblies have the advantage that no fasteners are required between the rotor and the hub. As a result, the integrated assemblies do not face problems associated with fasteners such as wear and fatigue near fastener openings and potential misalignment due to imperfect machining. A significant drawback, however, is that the assembly is constrained at the hub, which causes thermal distortion of the rotor. During braking, the rotor in such an assembly is subjected to high frictional forces that generate heat in the rotor causing thermal expansion/distortion, temperature variation across the face of the rotor, and heat transfer to the adjacent components including the hub and the bearings. Thermal expansion of the rotor is very limited because of the integral connection between the rotor and the hub, which results in thermal coning of the rotor surface and a large thermal gradient, which will induce high thermal stress leading to thermal cracking. The high thermal gradient generated during braking and the effects of the thermal expansion and distortion can cause vibration and thermal judder across the brake surfaces, resulting in rough or irregular braking pulsations reduce the life and performance of the rotor and increased maintenance costs. Such thermal distortion can damage the rotor and when the rotor is damaged or worn, the entire integrated assembly must be replaced. This is expensive and time consuming.

One way the thermal stresses have been addressed is to provide a “floating” rotor in which the fastener connection between the rotor and the hub is provided with a small clearance or float that allows thermal expansion. Advantageously, in these designs the rotor is mounted directly to the hub such that braking force is applied in-plane to the hub thus minimizing torsion or twist between the rotor and hub attachment, which can result in cracking and breaking of the rotor or hub.

However, stresses induced by conventional fastener assemblies in these designs are also a problem, even in floating rotor brakes. In most conventional designs the rotor is held against the hub with a series of bolts or studs capped with nuts at a central portion of the rotor. These bolts or studs absorb and transfer a major amount of the braking force to the hub and are thus subject to intense thermal and bending stresses during braking. As such, these parts represent another weak link in the system, and can break-off during maintenance procedures. Additionally, holes drilled in the rotors for receiving these connectors can weaken the overall design and likewise crack due to the thermal and torsional forces created during braking.

Several prior patents have endeavored to address one or more of the above-mentioned drawbacks, problems, or limitations of conventional disk brake designs.

U.S. Pat. No. 7,654,365 to Lamb discloses a two-piece floating disc brake assembly which comprises a hub with a plurality of radially extending drive cogs that engage a corresponding plurality of teeth that extend radially inwardly from the disc brake rotor. The disc is retained to the rotor by a plurality of retainers that are bolted to the axial outward surface of the brake rotor to engage the axial outward surfaces of the drive cogs. Axial float of the brake disc relative to the brake hub is provided by a plurality of axial slots between the drive cogs that are deeper than the thickness of the drive cogs. Because the axial clearance is established by the depth of the radial slots alone, tolerance on axially float is easier to maintain and is independent of the thickness of the brake disc.

U.S. Pat. No. 6,267,210 to Burgoon et al. discloses a hub rotor assembly including a hub, a rotor supported by the hub and a plurality of fasteners that connect the rotor to the hub and allow relative movement between the rotor and the hub. The hub rotor assembly of the invention focuses on a brake hub and rotor assembly that uses a floatation element associated with a fastener to fasten the rotor to the hub while allowing the rotor to move or float relative to the hub. The rotor thus fastened is permitted to move or float in a limited manner with respect to the hub. This reduces the need for precise balancing due to float self-balancing. Such floatation reduces first and second order thermal distortion by allowing the rotor to thermally expand and also accommodates and significantly reduces the temperature variation and thermal distortion across the rotor surface during braking. The assembly is particularly suited for commercial highway vehicles.

U.S. Pat. No. 8,651,247 to Burgoon et al. discloses a wheel bearing hub and disc brake rotor assembly for use on vehicles includes a rotor (14) and a wheel mount (24), formed as a package bearing, fastened to the rotor with a connection assembly that promotes in plane torque transfer. The rotor has a flange form as a series of spaced tabs (20), and the wheel bearing hub (12) has a shoulder with complementary spaced tabs (34). The rotor is connected to the bearing hub by clamping a bridge (42) that spans the shoulder tabs over the rotor tabs. A spring clip (50) can be use with the bridge to accommodate thermal expansion of the rotor and eliminate rattling. Torque is transferred from the brake rotor to the bearing hub in a common plane to prevent twisting. In one embodiment, the bearing hub shoulder tabs may be formed by milling or machining slots. In another embodiment, the bearing hub shoulder tabs may be formed by fine-blanking or stamping slots.

U.S. Published Patent Application No. 2009/0218183 to Burgoon et al. discloses a brake assembly for use on vehicles which includes a rotor having connection tabs and a hub having bobbins, integrally formed or separate, with the rotor connection tabs being positioned between the hub bobbins and clamped together with a top plate. An ABS tone ring is fastened to the hub and is circumscribed by the rotor. Alternatively, an ABS tone ring can be formed as part of the top plate. A spring clip can be used with the top plate to accommodate thermal expansion of the rotor and eliminate rotor rattling. Torque is transferred from the brake rotor to the hub in a common plane to prevent twisting in the fastener connection.

However, despite recent advances, there remains an unmet need in the art to optimize and simplify attachment of floating disk brake rotors to wheel hubs.

### SUMMARY

In one aspect, presented is a disc brake assembly, comprising a disc brake rotor secured between a mounting assembly and a taper-locking hold down ring.

In another aspect, the mounting assembly can be selected from a hat or a hub, for example a hat, and includes a cylindrical body portion having a radial mounting flange supporting the disc brake rotor.

Advantageously, the cylindrical body portion of the mounting assembly extends through a central aperture of the disc brake rotor and into the taper-locking hold down ring.

Additionally, the disc brake rotor can be sandwiched between the radial mounting flange and an inner flange on the taper-locking hold down ring.

In one form, the disc brake assembly has a series of tabs spaced about an inner circumference of a central aperture of the disc brake rotor and a corresponding series of slots spaced about an outer circumference of the mounting assembly, wherein the tabs fit into the slots.

In another form, the taper-locking hold down ring is a solid ring without gaps and has a first angle cut about the inner circumference of the ring, the first angle selected to conform to or mate with a second angle cut on an outer circumference of the cylindrical body portion. Advantageously, the first and second angles coact to bias the taper-locking hold down ring against the disc brake rotor.

In another form, the taper-locking hold down ring is sized to surround an outer circumference of the cylindrical body portion of the mounting assembly which extends through a central aperture of the disc brake rotor.

Optionally, the taper-locking hold down ring has a series of exciter teeth spaced about its outer circumference.

Depending on the desired use, the mounting assembly, the disc brake rotor and the taper-locking hold down ring can be independently made from cast iron, steel, aluminum, ceramic or a metal composite material.

In one form, the taper-locking hold down ring sandwiches a spring between itself and the disc brake rotor.

In another form, presented is a disc brake assembly including a hat or a hub having a cylindrical body portion and a mounting flange on a first end of the cylindrical body portion, a rotor disc having an inner circumferential aperture with inwardly extending portions, through which the rotor is mounted on the cylindrical body portion of the hat or hub, and a taper-locking hold down ring which is a continuous solid ring disposed about a second end of the cylindrical body portion of the hat or hub extending through the inner circumferential aperture of the rotor disc, having an inner flange abutting and biased against the inwardly extending portions of the inner circumferential aperture of the rotor disc.

In one form, the inwardly extending portions of the inner circumferential aperture of the rotor disc include a series of tabs spaced about the inner circumferential aperture, the hat or hub mounting flange further includes a corresponding series of slots spaced along an outer circumferential surface thereof, and the tabs are fitted into the slots.

In another form, the inner flange of the taper-locking hold down ring abuts the spaced tabs of the rotor disc.

Conveniently, the taper-locking hold down ring of the disc brake assembly has a first angle cut about the inner circumference of the ring, the first angle selected to conform to a second angle cut about an outer circumference of the second end of the cylindrical body portion of the hat.

Advantageously, the first and second angles coact to bias the taper-locking hold down ring against the inwardly extending portions of the inner circumferential aperture of the rotor disc.

In one form, the first and second angles coact to bias the inner flange of the taper-locking hold down ring against the spaced tabs of the rotor disc.

In another form, the taper-locking hold down ring is sized to surround an outer circumference of the second end of the cylindrical body portion of the hat.

Optionally, the taper-locking hold down ring has a series of exciter teeth spaced about its outer circumference.

Depending on the desired use, the hat, the rotor disc and the taper-locking hold down ring can be independently made from cast iron, steel, aluminum, ceramic or a metal composite material.

In another form, the disc brake assembly further comprises a disc spring sandwiched between the taper-locking hold down ring and the disc brake rotor.

Additionally presented is a method of securing a disc brake rotor to a mounting assembly, which can be a hub, a hat or a mount, including providing a mounting assembly having a cylindrical body with a mounting flange on a first end of the cylindrical body, fixedly mounting a disc brake rotor onto the cylindrical body, and mounting a taper-locking hold down ring on a second end of the cylindrical body, opposite the mounting flange and biased against the disc brake rotor, such that the disc brake rotor is restricted from rotational or axial movement relative to the cylindrical body. In one form, the mounting assembly is a hat. In another form the mounting assembly is a hub.

The method further includes heating and expanding the taper-locking hold down ring prior to mounting it onto the second end of the cylindrical body, and allowing the taper-locking hold down ring to cool and shrink.

In one form, the method further includes providing both the taper-locking hold down ring and the second end of the cylindrical body with coacting tapers to bias the taper-locking hold down ring against the disc brake rotor to provide the restriction against axial movement.

In an alternative form, the method can further comprise mounting a disc spring onto the cylindrical body and against the disc brake rotor, followed by mounting of the taper-locking hold down ring.

Advantageously, the disc brake rotor is provided with inwardly extending tabs spaced about an inner circumferential aperture thereof, and the mounting flange is provided with cooperating slots spaced about an outer circumferential surface thereof to provide the restriction against rotational movement.

### BRIEF DESCRIPTION OF THE DRAWINGS

The present disclosure is susceptible to various modifications and alternative forms, specific exemplary implementations thereof have been shown in the drawings and are herein described in detail. It should be understood, however, that the description herein of specific exemplary implementations is not intended to limit the disclosure to the particular forms disclosed herein. This disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles. Further where considered appropriate, reference numerals may be repeated among the drawings to indicate corresponding or analogous elements. Moreover, two or more blocks or elements depicted as distinct or separate in the drawings may be combined into a single functional block or element. Similarly, a single block or element illustrated in the drawings may be implemented as multiple steps or by multiple elements in cooperation. The forms disclosed herein are illustrated by way of example, and not by way of limitation, in the figures of the accompanying drawings and in which like reference numerals refer to similar elements and in which:

FIG. 1 is an exploded plan view of the disc brake assembly of the present invention;

FIG. 2 is an exploded side view of the disc brake assembly of the present invention;

FIG. 3 is a cross-sectional view of the assembled disc brake assembly of the present invention;

FIG. 4 is an enlarged view of the cross-sectional portion “4” from FIG. 3;

FIG. 5 is an exploded plan view of an alternative disc brake assembly of the present invention;

FIG. 6 is an exploded side view of the alternative disc brake assembly of FIG. 5;

FIG. 7 is a cross-sectional view of the assembled alternative disc brake assembly of the present invention; and

FIG. 8 is an enlarged view of the cross-sectional portion “8” from FIG. 7.

### DETAILED DESCRIPTION

### Terminology

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise. For example, the phrases “a device,” “an assembly,” “a mechanism,” “a component,” and “an element,” as used herein, may also refer to, and encompass, a plurality of devices, a plurality of assemblies, a plurality of mechanisms, a plurality of components, and a plurality of elements, respectively.

Each of the following terms: “includes,” “including,” “has,” “‘having,” “comprises,” and “comprising,” and, their linguistic or grammatical variants, derivatives, and/or conjugates, as used herein, means “including, but not limited to.”

About: As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

Above/below: In the following description of the representative embodiments of the invention, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore. Continuing with the example of relative directions in a wellbore, “upper” and “lower” may also refer to relative positions along the longitudinal dimension of a wellbore rather than relative to the surface, such as in describing both vertical and horizontal wells.

And/or: The term “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements). As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”.

Any: The adjective “any” means one, some, or all indiscriminately of whatever quantity.

At least: As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements). The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Based on: “Based on” does not mean “based only on”, unless expressly specified otherwise. In other words, the phrase “based on” describes both “based only on,” “based at least on,” and “based at least in part on.”

Couple: Any use of any form of the terms “connect”, “engage”, “couple”, “attach”, or any other term describing an interaction between elements is not meant to limit the interaction to direct interaction between the elements and may also include indirect interaction between the elements described.

Determining: “Determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

Embodiments (Forms): Reference throughout the specification to “one embodiment,” “an embodiment,” “some embodiments,” “one aspect,” “an aspect,” “some aspects,” “some implementations,” “one implementation,” “an implementation,” or similar construction means that a particular component, feature, structure, method, or characteristic described in connection with the embodiment, aspect, or implementation is included in at least one embodiment and/or implementation of the claimed subject matter. Thus, the appearance of the phrases “in one embodiment” or “in an embodiment” or “in some embodiments” (or “aspects” or “implementations”) in various places throughout the specification are not necessarily all referring to the same embodiment and/or implementation. Furthermore, the particular features, structures, methods, or characteristics may be combined in any suitable manner in one or more embodiments or implementations.

Exemplary: “Exemplary” is used exclusively herein to mean “serving as an example, instance, or illustration.” Any embodiment described herein as “exemplary” is not necessarily to be construed as preferred or advantageous over other embodiments.

May: Note that the word “may” is used throughout this application in a permissive sense (i.e., having the potential to, being able to), not a mandatory sense (i.e., must).

Operatively connected and/or coupled: Operatively connected and/or coupled means directly or indirectly connected for transmitting or conducting information, force, energy, or matter.

Optimizing: The terms “optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms may describe one or more of: 1) working towards a solution which may be the best available solution, a preferred solution, or a solution that offers a specific benefit within a range of constraints; 2) continually improving; 3) refining; 4) searching for a high point or a maximum for an objective; 5) processing to reduce a penalty function; 6) seeking to maximize one or more factors in light of competing and/or cooperative interests in maximizing, minimizing, or otherwise controlling one or more other factors, etc.

Order of steps: It should also be understood that, unless clearly indicated to the contrary, in any methods claimed herein that include more than one step or act, the order of the steps or acts of the method is not necessarily limited to the order in which the steps or acts of the method are recited.

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the method or to the details of type, composition, construction, arrangement, order and number of the system, system sub-units, devices, assemblies, sub-assemblies, mechanisms, structures, components, elements, and configurations, and, peripheral equipment, utilities, accessories, and materials of forms of the system, set forth in the following illustrative description, accompanying drawings, and examples, unless otherwise specifically stated herein. The apparatus, systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

### DESCRIPTION

This invention relates to a disc brake assembly which is both light weight and cost effective, and can be used with any of light duty vehicles, heavy duty vehicles, trucks, buses and railway vehicles.

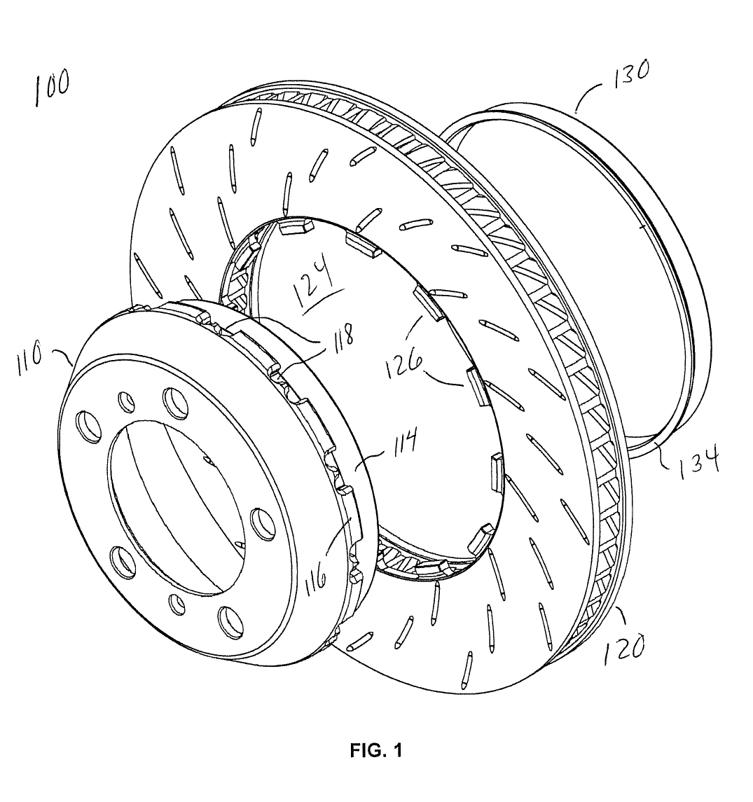

As illustrated in FIG. 1, which is an exploded plan view of the assembly, the disc brake assembly 100 has only three main parts: a disc brake rotor 120, which is secured between a mounting assembly 110 and a taper-locking hold down ring 130. The mounting assembly 110 can be selected from a hat or a hub, or any other such assembly which conforms to the requirements discussed below.

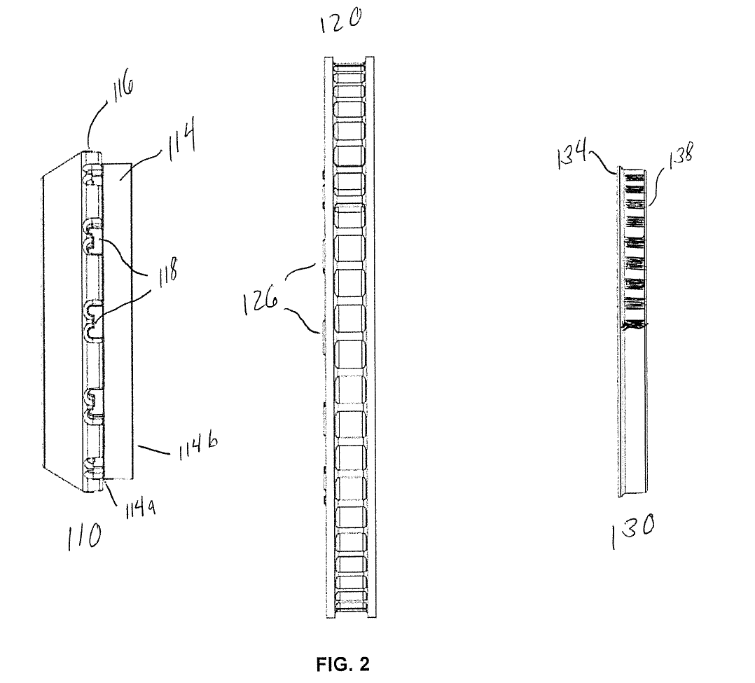

For example, the mounting assembly 110 can be a hat, which includes a cylindrical body portion 114 having a radial mounting flange 116, which supports the disc brake rotor 120. The radial mounting flange maintains axial alignment of the disc brake rotor 120 on one side, and the cylindrical body portion 118 extends through a central aperture 124 of the disc brake rotor 120 and into the taper-locking hold down ring 130, which constrains the disc brake rotor 120 from axial movement in the other direction. Accordingly, as can be more readily understood from FIG. 2, which is an exploded side view, the disc brake rotor 120 is sandwiched between the radial mounting flange 116 of the mounting assembly 110 and an inner flange 134 on the taper-locking hold down ring 130.

The disc brake rotor 120 is provided with a series of tabs 126 (FIG. 1) spaced about an inner circumference of the central aperture 124 of the disc brake rotor 120 and the mounting assembly is provided with a corresponding series of slots 118 spaced about its outer circumference. The rotor is mounted onto the radial flange of the mounting assembly such that the inwardly facing tabs of the rotor fit into the outwardly facing slots of the radial flange.

The disc brake assembly is held together axially by a taper-locking hold down ring 130, which is a solid ring without gaps, having a tapered face about the inner circumference of the ring 130. The taper-locking hold down ring differs from earlier locking rings, such as snap rings, in that there is no gap in the ring, i.e. the taper-locking hold down ring of the present invention is continuous, and is shrink-fit onto the cylindrical body portion of the mounting assembly.

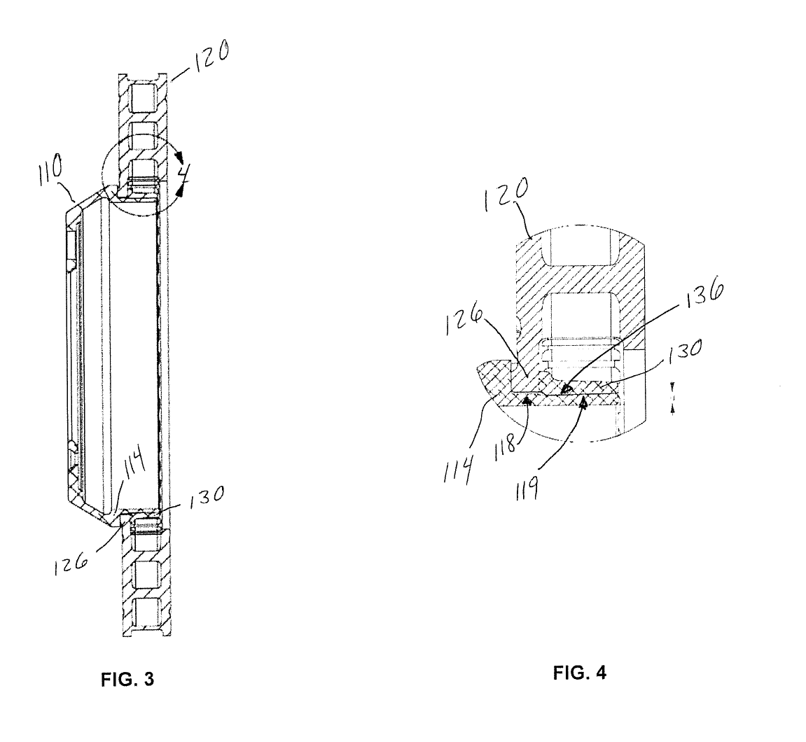

The taper-locking hold down ring has (FIG. 4) a first angle cut 136 which is selected to conform to or mate with a second angle cut 119 on an outer circumference of the cylindrical body portion 114 of the mounting assembly. The angle cuts 136 and 119 are machined or cast to be at an angle α relative to the inner surface of the cylindrical body portion 114 and/or the axis of the disc brake assembly, and taper from the inner portions of the rotor disc 120 at angle α to the outer circumference of the taper-locking hold down ring 130, such that the first and second angles coact to bias the taper-locking hold down ring against the disc brake rotor. As can best be seen in FIG. 3, the taper-locking hold down ring 130 is sized to surround an outer circumference of the cylindrical body portion 114 of the mounting assembly 110 which extends through a central aperture 124 of the disc brake rotor 120.

Optionally, such as when used with an anti-lock braking system (ABS), the taper-locking hold down ring 134 can have a series of exciter teeth 138 (FIG. 2) spaced about its outer circumference to form a tone ring. The rotating teeth 138 are read by an anti-lock brake sensor (not shown) that generates a signal for the anti-lock brake control system representative of the rotation of the wheel associated with the rotor disc 120. The sensor reads the peaks of the teeth and the valleys between adjacent teeth and uses an algorithm to determine whether the associated wheel is slipping. If it is determined that the wheel is slipping, braking pressure is released. Obviously, the arrangement and geometry of the teeth influence the signal generated by the sensor. To ensure proper operation of the anti-lock brake system, the teeth must be regularly spaced, sized, and maintained to preserve the profile of the teeth. Many sensors use magnetic pulse generation, which is created as the teeth pass by the sensor. The strength and accuracy of the signal is determined by the magnetic properties of the tone ring and the ring's geometric accuracy. Inadequate magnetic signal strength or incorrect geometric shape may cause signal failure, which can be further influenced by rotating velocity.

According to the needs and/or desired uses of the disc brake assembly 100, the mounting assembly 110, the disc brake rotor 120 and the taper-locking hold down ring 130 can be independently made from cast iron, steel, aluminum, ceramic or a metal composite material. That is, any or all of the components can be made of the same material, or of different materials, as needed.

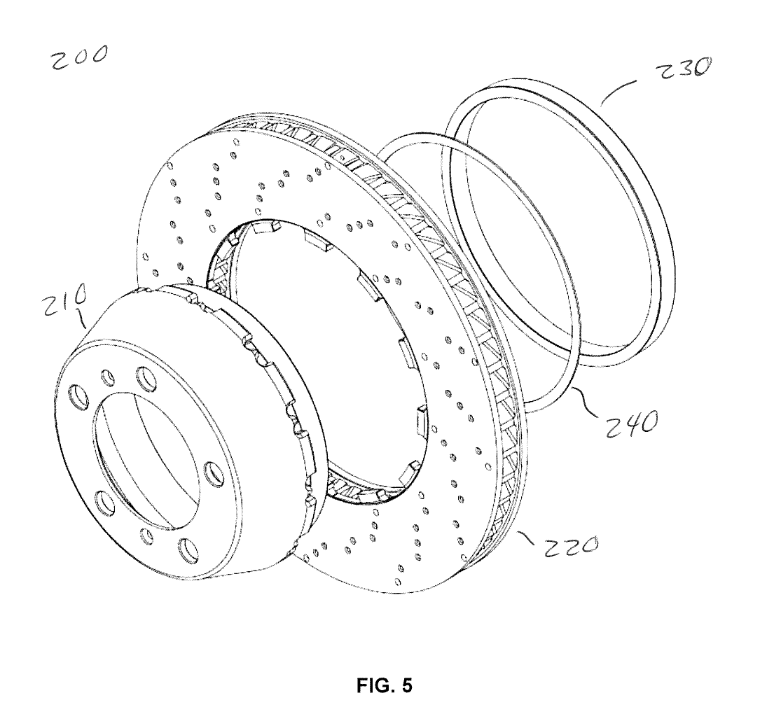

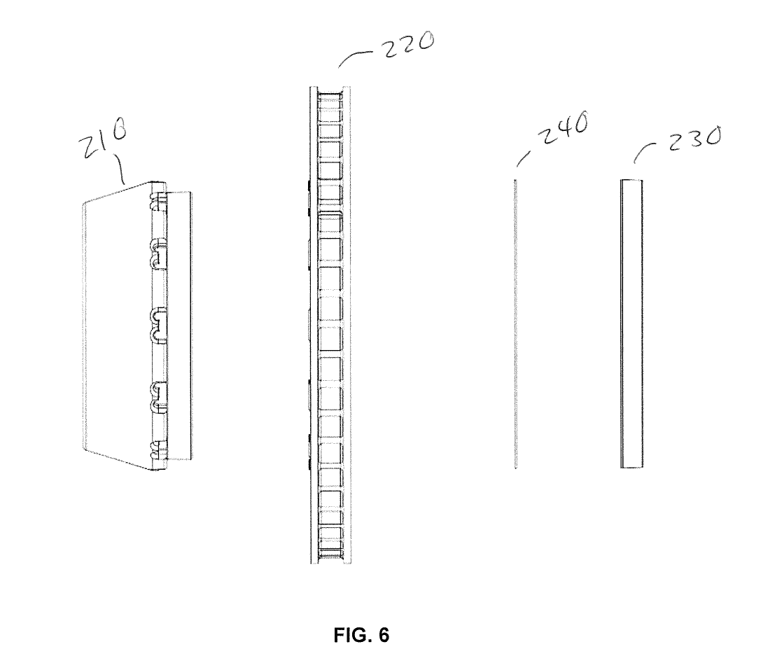

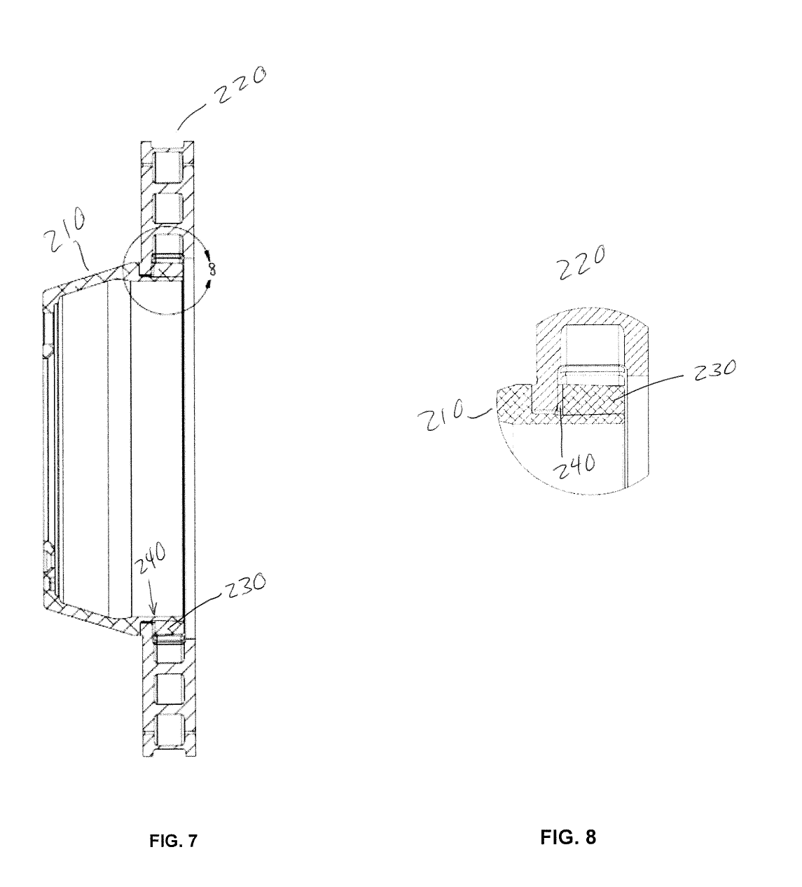

In another embodiment of a disc brake assembly 200 (FIGS. 5-8) the taper-locking hold down ring 230 sandwiches a spring 240 between itself and the disc brake rotor 220, which is biased against mounting assembly 210. The spring can be a disc shaped spring, such as a Belleville spring or wave spring, and is effective to pretension the rotor against the hat to prevent rattling under normal use, and at the same time allow float in the axial direction to accommodate for significant axial forces, such as might be experienced in high lateral force turning or when the tire experiences impact loading.

In another form the invention is directed to a disc brake assembly 100 comprising a hat or hub 110 having a cylindrical body portion 114 and a mounting flange 116 on a first end 114a of the cylindrical body portion, a rotor disc 120 having an inner circumferential aperture 124 with inwardly extending portions 126, such as tabs, through which the rotor 120 is mounted on said cylindrical body portion 114 of the hat or hub 110, and a taper-locking hold down ring 130 which is a continuous solid ring disposed about a second end 114b of the cylindrical body portion 114 of the hat or hub 110 extending through the inner circumferential aperture 124 of the rotor disc 120, having an inner flange 134 abutting and biased against the inwardly extending portions or tabs 126 of the inner circumferential aperture 124 of the rotor disc 120.

Preferably, the inwardly extending portions of the inner circumferential aperture of the rotor disc comprise a series of tabs 126 spaced about said inner circumferential aperture 124, and the hat or hub mounting flange 110 further comprises a corresponding series of slots 118 spaced along an outer circumferential surface thereof, the tabs 126 are fitted into the slots 118, and the inner flange 134 of the taper-locking hold down ring 130 abuts said spaced tabs of the rotor disc. As discussed above, the taper-locking hold down ring 130 has an angle α cut 136 about its inner circumference, conforming to or mating with a second angle cut 119 about an outer circumference of said second end of the cylindrical body portion of the hat, and the angle cuts coact to bias the taper-locking hold down ring, particularly the inner flange thereof, against the inwardly extending portions or tabs of the inner circumferential aperture of the rotor disc.

Another aspect of the invention is a method of securing a disc brake rotor to a mounting assembly, such as a hub, a hat or a mount, comprising providing a mounting assembly having a cylindrical body with a mounting flange on a first end of said cylindrical body, fixedly mounting a disc brake rotor onto said cylindrical body, and mounting a taper-locking hold down ring on a second end of the cylindrical body, opposite said mounting flange and biased against the disc brake rotor, such that the disc brake rotor is restricted from rotational or axial movement relative to the cylindrical body.

The taper-locking hold down ring is mounted onto the cylindrical body of the mounting assembly by shrink-fitting, comprising heating and expanding the taper-locking hold down ring prior to mounting it onto said second end of the cylindrical body, and allowing the taper-locking hold down ring to cool and shrink.

As discussed above, both the taper-locking hold down ring and the second end of the cylindrical body are provided with coacting tapers to bias the taper-locking hold down ring against the disc brake rotor to provide the restriction against axial movement of the rotor away from the mounting flange. The disc brake rotor is provided with inwardly extending tabs spaced about an inner circumferential aperture thereof, and the mounting flange is provided with cooperating slots spaced about an outer circumferential surface thereof to provide the restriction against rotational movement.

Further illustrative, non-exclusive examples of assemblies and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

PCT1. A disc brake assembly, comprising a disc brake rotor secured between a mounting assembly, such as a hat or a hub having a cylindrical body portion, and a taper-locking hold down ring.

PCT2. The disc brake assembly of paragraph PCT1, wherein the mounting assembly is a hat which includes a cylindrical body portion having a radial mounting flange supporting the disc brake rotor.

PCT3. The disc brake assembly of paragraph PCT1 or PCT2, wherein the cylindrical body portion extends through a central aperture of the disc brake rotor and into the taper-locking hold down ring.

PCT4. The disc brake assembly of any of the preceding PCT paragraphs, wherein the disc brake rotor is sandwiched between the radial mounting flange and an inner flange on the taper-locking hold down ring.

PCT5. The disc brake assembly of any of the preceding PCT paragraphs, further comprising a series of tabs spaced about an inner circumference of a central aperture of the disc brake rotor and a corresponding series of slots spaced about an outer circumference of said mounting assembly, wherein the tabs fit into the slots.

PCT6. The disc brake assembly of any of the preceding PCT paragraphs, wherein the taper-locking hold down ring is a solid ring without gaps and has a first angle cut about the inner circumference of the ring, said first angle selected to conform to a second angle cut on an outer circumference of the cylindrical body portion, such that the first and second angles coact to bias the taper-locking hold down ring against the disc brake rotor.

PCT7. The disc brake assembly of any of the preceding PCT paragraphs, wherein the taper-locking hold down ring is sized to surround an outer circumference of the cylindrical body portion of the mounting assembly which extends through a central aperture of the disc brake rotor.

PCT8. The disc brake assembly of any of the preceding PCT paragraphs, wherein the taper-locking hold down ring has a series of exciter teeth spaced about its outer circumference.

PCT9. The disc brake assembly of any of the preceding PCT paragraphs, wherein the mounting assembly, the disc brake rotor and the taper-locking hold down ring are independently made from cast iron, steel, aluminum, ceramic or a metal composite material.

PCT10. The disc brake assembly of any of the preceding PCT paragraphs, further comprising a disc spring sandwiched between the taper-locking hold down ring and the disc brake rotor.

PCT11. A method of securing a disc brake rotor to a hub, a hat or a mount, comprising providing a mounting assembly having a cylindrical body with a mounting flange on a first end of said cylindrical body, fixedly mounting a disc brake rotor onto said cylindrical body, and mounting a taper-locking hold down ring on a second end of the cylindrical body, opposite said mounting flange and biased against the disc brake rotor, such that the disc brake rotor is restricted from rotational or axial movement relative to the cylindrical body.

PCT12. The method of paragraph PCT11, further comprising heating and expanding the taper-locking hold down ring prior to mounting it onto said second end of the cylindrical body, and allowing the taper-locking hold down ring to cool and shrink.

PCT13. The method of paragraph PCT11 or PCT12, further comprising providing both the taper-locking hold down ring and the second end of the cylindrical body with coacting tapers to bias the taper-locking hold down ring against the disc brake rotor to provide the restriction against axial movement.

PCT14. The method of any of paragraphs PCT11 to PCT13, wherein the disc brake rotor is provided with inwardly extending tabs spaced about an inner circumferential aperture thereof, and the mounting flange is provided with cooperating slots spaced about an outer circumferential surface thereof to provide the restriction against rotational movement.

PCT15. The method of any of paragraphs PCT11 to PCT14, further comprising mounting a disc spring onto said cylindrical body and against the disc brake rotor, followed by mounting of said taper-locking hold down ring.

PCT16. A disc brake assembly, comprising a hat or hub having a cylindrical body portion and a mounting flange on a first end of the cylindrical body portion, a rotor disc having an inner circumferential aperture with inwardly extending portions, through which the rotor is mounted on said cylindrical body portion of the hat or hub, and a taper-locking hold down ring which is a continuous solid ring disposed about a second end of the cylindrical body portion of the hat or hub extending through the inner circumferential aperture of the rotor disc, having an inner flange abutting and biased against the inwardly extending portions of the inner circumferential aperture of the rotor disc.

PCT17. The disc brake assembly of paragraph PCT16, wherein the inwardly extending portions of the inner circumferential aperture of the rotor disc comprise a series of tabs spaced about said inner circumferential aperture, the hat or hub mounting flange further comprises a corresponding series of slots spaced along an outer circumferential surface thereof, and the tabs are fitted into the slots.

PCT18. The disc brake assembly of paragraph PCT16 or PCT17, wherein the inner flange of the taper-locking hold down ring abuts said spaced tabs of the rotor disc and the taper-locking hold down ring has a first angle cut about the inner circumference of the ring, said first angle selected to conform to a second angle cut about an outer circumference of said second end of the cylindrical body portion of the hat, such that the first and second angles coact to bias the taper-locking hold down ring against the inwardly extending portions, such as the tabs spaced about the inner circumferential aperture of the rotor disc.

PCT19. The disc brake assembly of any of paragraphs PCT16 to PCT18, wherein the taper-locking hold down ring is sized to surround an outer circumference of the second end of the cylindrical body portion of the hat.

PCT20. The disc brake assembly of any of paragraphs PCT16 to PCT19, wherein the taper-locking hold down ring has a series of exciter teeth spaced about its outer circumference.

PCT21. The disc brake assembly of any of paragraphs PCT16 to PCT20, further comprising a disc spring sandwiched between the taper-locking hold down ring and the disc brake rotor.

### INDUSTRIAL APPLICABILITY

The apparatus and methods disclosed herein are applicable to the automotive industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A disc brake assembly, comprising a disc brake rotor secured between a mounting assembly and a taper-locking hold down ring.

2. The disc brake assembly of claim 1, wherein the mounting assembly is selected from a hat or a hub.

3. The disc brake assembly of claim 1, wherein the mounting assembly is a hat which includes a cylindrical body portion having a radial mounting flange supporting the disc brake rotor.

4. The disc brake assembly of claim 3, wherein the cylindrical body portion extends through a central aperture of the disc brake rotor and into the taper-locking hold down ring.

5. The disc brake assembly of claim 3, wherein the disc brake rotor is sandwiched between the radial mounting flange and an inner flange on the taper-locking hold down ring.

6. The disc brake assembly of claim 1, further comprising a series of tabs spaced about an inner circumference of a central aperture of the disc brake rotor and a corresponding series of slots spaced about an outer circumference of said mounting assembly, wherein the tabs fit into the slots.

7. The disc brake assembly of claim 3, wherein the taper-locking hold down ring is a solid ring without gaps and has a first angle cut about the inner circumference of the ring, said first angle selected to conform to a second angle cut on an outer circumference of the cylindrical body portion.

8. The disc brake assembly of claim 7, wherein the first and second angles coact to bias the taper-locking hold down ring against the disc brake rotor.

9. The disc brake assembly of claim 1, wherein the taper-locking hold down ring is sized to surround an outer circumference of the cylindrical body portion of the mounting assembly which extends through a central aperture of the disc brake rotor.

10. The disc brake assembly of claim 1, wherein the taper-locking hold down ring has a series of exciter teeth spaced about its outer circumference.

11. The disc brake assembly of claim 1, wherein the mounting assembly, the disc brake rotor and the taper-locking hold down ring are independently made from cast iron, steel, aluminum, ceramic or a metal composite material.

12. The disc brake assembly of claim 1, further comprising a disc spring sandwiched between the taper-locking hold down ring and the disc brake rotor.

13. A disc brake assembly, comprising
a hat or a hub having a cylindrical body portion and a mounting flange on a first end of the cylindrical body portion;
a rotor disc having an inner circumferential aperture with inwardly extending portions, through which the rotor is mounted on said cylindrical body portion of the hat or hub; and
a taper-locking hold down ring which is a continuous solid ring disposed about a second end of the cylindrical body portion of the hat or hub extending through the inner circumferential aperture of the rotor disc, having an inner flange abutting and biased against the inwardly extending portions of the inner circumferential aperture of the rotor disc.

14. The disc brake assembly of claim 13, wherein the inwardly extending portions of the inner circumferential aperture of the rotor disc comprise a series of tabs spaced about said inner circumferential aperture, the hat or hub mounting flange further comprises a corresponding series of slots spaced along an outer circumferential surface thereof, and the tabs are fitted into the slots.

15. The disc brake assembly of claim 14, wherein the inner flange of the taper-locking hold down ring abuts said spaced tabs of the rotor disc.

16. The disc brake assembly of claim 13, wherein the taper-locking hold down ring has a first angle cut about the inner circumference of the ring, said first angle selected to conform to a second angle cut about an outer circumference of said second end of the cylindrical body portion of the hat or hub.

17. The disc brake assembly of claim 16, wherein the first and second angles coact to bias the taper-locking hold down ring against the inwardly extending portions of the inner circumferential aperture of the rotor disc.

18. The disc brake assembly of claim 16, wherein the first and second angles coact to bias the inner flange of the taper-locking hold down ring against the spaced tabs of the rotor disc.

19. The disc brake assembly of claim 13, wherein the taper-locking hold down ring is sized to surround an outer circumference of the second end of the cylindrical body portion of the hat or hub.

20. The disc brake assembly of claim 13, wherein the taper-locking hold down ring has a series of exciter teeth spaced about its outer circumference.

21. The disc brake assembly of claim 13, wherein the hat or hub, the rotor disc and the taper-locking hold down ring are independently made from cast iron, steel, aluminum, ceramic or a metal composite material.

22. The disc brake assembly of claim 13, further comprising a disc spring sandwiched between the taper-locking hold down ring and the disc brake rotor.

23. A method of securing a disc brake rotor to a mounting assembly including a hub, a hat or a mount, comprising:
providing a mounting assembly having a cylindrical body with a mounting flange on a first end of said cylindrical body;
fixedly mounting a disc brake rotor onto said cylindrical body; and
mounting a taper-locking hold down ring on a second end of the cylindrical body, opposite said mounting flange and biased against the disc brake rotor,
such that the disc brake rotor is restricted from rotational or axial movement relative to the cylindrical body.

24. The method of claim 23, further comprising heating and expanding the taper-locking hold down ring prior to mounting it onto said second end of the cylindrical body, and allowing the taper-locking hold down ring to cool and shrink.

25. The method of claim 23, further comprising providing both the taper-locking hold down ring and the second end of the cylindrical body with coacting tapers to bias the taper-locking hold down ring against the disc brake rotor to provide the restriction against axial movement.

26. The method of claim 23, wherein the disc brake rotor is provided with inwardly extending tabs spaced about an inner circumferential aperture thereof, and the mounting flange is provided with cooperating slots spaced about an outer circumferential surface thereof to provide the restriction against rotational movement.

27. The method of claim 23, further comprising mounting a disc spring onto said cylindrical body and against the disc brake rotor, followed by mounting of said taper-locking hold down ring.

28. The method of claim 23, wherein the mounting assembly comprises a hat.

29. The method of claim 23, wherein the mounting assembly comprises a hub.
